(19) United States
(12) Patent Application Publication
(10) Pub. No.: US 2011/0035330 A1
(43) Pub. Date: Feb. 10, 2011

(54) Quality Control of Investment Performance Calculations

(75) Inventors: Francis Li, Concord, MA (US); Stephen Dorato, Swampscott, MA (US); Nixon Lim, East Windsor, NJ (US); Jon Reese, New Providence, NJ (US)

Correspondence Address: PROSKAUER ROSE LLP, ONE INTERNATIONAL PLACE, BOSTON, MA, 02110, US

(73) Assignee: FMR LLC, Boston, MA (US)

(21) Appl. No.: 12/537,794

(22) Filed: Aug. 7, 2009

(51) Int. Cl. G06Q 40/00

(52) U.S. Cl. 705/36 R

(57) ABSTRACT

Described are methods and apparatuses, including computer program products, for quality control of investment performance calculations. Performance data associated with one or more investment accounts is received by a server computing device. A tolerance range associated with the performance data is generated. A portion of the performance data is identified for filtering based on the tolerance range. The identified performance data is processed through a plurality of filters, wherein the filters are based on predefined rules. A first portion of the filtered data is marked as requiring no further review. A second portion of the filtered data is marked as requiring further review.

### FIELD OF THE INVENTION

The subject matter of this application relates generally to methods and apparatuses, including computer program products, for quality control of investment performance calculations.

### BACKGROUND OF THE INVENTION

Investment performance measurement is the quantification of the results achieved by an investment program. Accurate and timely calculation of investment performance metrics is essential to providing investors with a true reflection of their currently-held assets and changes in the assets' value over time.

For many large brokerage firms, which maintain millions of individual investment accounts containing a multitude of securities, the sheer volume of performance-related calculations associated with those accounts necessitates an efficient and reliable way to determine the existence of inaccurate or unexpected data, and correct the inaccuracies or verify the calculations as needed.

### SUMMARY

In one aspect, there is a computerized method for quality control of investment performance calculations. Performance data associated with one or more investment accounts is received by a server computing device. A tolerance range associated with the performance data is generated. A portion of the performance data is identified for filtering based on the tolerance range. The identified performance data is processed through a plurality of filters, wherein the filters are based on predefined rules. One or more data points within the identified portion of the performance data are identified as requiring no further review based on the processing. One or more data points within the identified portion of the performance data are identified as requiring further review based on the processing.

In another aspect, there is a system for quality control of investment performance calculations. The system comprises a server computing device configured to receive performance data associated with one or more investment accounts. A tolerance range associated with the performance data is generated. A portion of the performance data is identified for filtering based on the tolerance range. The identified performance data is processed through a plurality of filters, wherein the filters are based on predefined rules. One or more data points within the identified portion of the performance data are identified as requiring no further review based on the processing. One or more data points within the identified portion of the performance data are identified as requiring further review based on the processing.

In another aspect, there is a computer program product for quality control of investment performance calculations. The computer program product is tangibly embodied in a computer readable storage medium. The computer program product includes instructions operable to cause a data processing apparatus to receive performance data associated with one or more investment accounts. A tolerance range associated with the performance data is generated. A portion of the performance data is identified for filtering based on the tolerance range. The identified performance data is processed through a plurality of filters, wherein the filters are based on predefined rules. One or more data points within the identified portion of the performance data are identified as requiring no further review based on the processing. One or more data points within the identified portion of the performance data are identified as requiring further review based on the processing.

In another aspect, there is a system for quality control of investment performance calculations. The system includes means for receiving performance data associated with one or more investment accounts. The system includes means for generating a tolerance range associated with the performance data. The system includes means for identifying a portion of the performance data for filtering based on the tolerance range. The system includes means for processing the identified performance data through a plurality of filters, wherein the filters are based on predefined rules. The system includes means for identifying one or more data points within the identified portion of the performance data as requiring no further review based on the processing. The system includes means for identifying one or more data points within the identified portion of the performance data as requiring further review based on the processing.

In some examples, any of the aspects can include one or more of the following features. The identifying can include comparing the performance data with the tolerance range, and identifying the portion of the performance data that is not within the tolerance range. The identifying one or more data points within the identified portion of the performance data as requiring no further review based on the processing includes inserting data associated with the one or more data points requiring no further review into a data set associated with one of the plurality of filters. The inserted data can include an identifier associated with an investment account, a timestamp, a corrected data value, a closure flag, a comment text field, or any combination thereof.

In other examples, the processing can include processing the identified performance data serially through the plurality of filters, wherein the plurality of filters is arranged in a predetermined order. The predefined rules can include a market performance type, a missing data type, an account activity type, an estimated return type, and a prior resolution type.

In some examples, wherein the predefined rule is a market performance type, the processing can include adjusting the performance data based on market movement data. In other examples, wherein the predefined rule is a missing data type, the processing can include determining that at least a portion of the performance data has a zero or missing price. The processing can include determining that the portion of the performance data with a zero or missing price is associated with an investment security having no value.

In some examples, wherein the predefined rule is an account activity type, the processing can include determining that at least a portion of the performance data is associated with one or more investment accounts having a low asset value. In other examples, wherein the predefined rule is an account activity type, the processing can include determining that a portion of the performance data is associated with one or more investment accounts having a change in asset value that exceeds a minimum percentage.

In still other examples, wherein the predefined rule is an estimated return type, the processing can include calculating a proxy rate of return for at least a portion of the identified performance data, comparing the proxy rate of return with one or more data points within the identified portion of the performance data, and determining that the one or more data points within the identified portion of the performance data do not require further review based on the comparison.

In some examples, wherein the predefined rule is a prior resolution type, the processing can include comparing one or more data points within the identified performance data with resolution data from a selected time period, wherein the one or more data points of the identified performance data and the resolution data are associated with the same investment account, and determining that the one or more data points of the identified performance data do not require further review based on the comparison. The resolution data is associated with one or more data points identified during the selected time period as requiring further review. The selected time period can be the previous week. The selected time period can be the month-to-date.

In other examples, the performance data is a money weighted rate-of-return, a time-weighted rate of return, or any combination thereof. The money weighted rate-of-return and the time weighted rate-of-return can be associated with a single investment account. In still other examples, the tolerance range can be based on a distribution of at least a portion of the performance data.

Any of the examples described herein can contain one or more of the following advantages. Since the system and method utilize iterative data review and posting techniques with reference to prior validated results, discrepancies and errors can be quickly identified for processing. The techniques leverage knowledge about frequently-occurring errors to create data filters which process and close a large portion of those errors automatically. The techniques also provide the capability for intelligent self-learning in that the past experience with and resolution of specific types of discrepancies are applied to present data, decreasing the time it takes to validate the investment performance calculations. Finally, the techniques greatly reduce the target population of data that must be analyzed and corrected during the quality control process using traditionally less efficient methods (e.g., manual review). All of these advantages contribute to enhancing the productivity of personnel tasked with the quality control of investment performance data by allowing them to focus on more challenging or higher priority issues while automatically resolving a large portion of the discrepancies commonly appearing in investment performance data.

### DESCRIPTION OF FIGURES

FIG. 1 is a block diagram of an exemplary system for quality control of investment performance calculations.

FIG. 2 is a workflow diagram of an exemplary method for quality control of investment performance calculations.

FIG. 3 is a detailed block diagram of the plurality of filters within the data filtration module for processing investment performance data to identify one or more data points requiring further review.

FIG. 4 is a workflow diagram of an exemplary method for determining a proxy rate of return for an investment account.

FIG. 5 is a diagram depicting an exemplary iterative month-to-date posting period schedule 500.

### DETAILED DESCRIPTION

In general overview, the techniques described below includes methods and apparatuses that are for quality control of investment performance calculations. The techniques, including both methods and apparatuses, are related to receiving performance data associated with investment accounts, comparing the performance data against a predefined tolerance range to determine if a portion of the data is outside the tolerance range, and processing the portion of the data through a number of different filters. Once the data has been filtered, the techniques include identification of data points within the performance data for further review or closure.

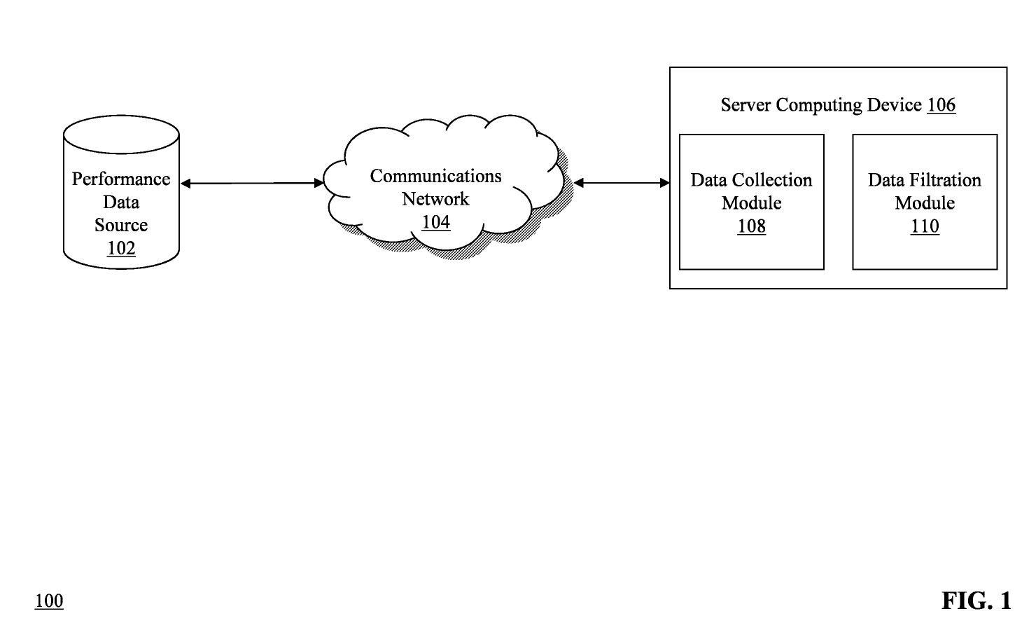

FIG. 1 is a block diagram of an exemplary system 100 for quality control of investment performance calculations. The system 100 includes a performance data source 102, a communications network 104, and a server computing device 106. The server 106 includes a data collection module 108 and a data filtration module 110. The performance data source 102 and the server 106 can reside at the same physical location or may be dispersed to different physical locations. The performance data source 102 and the server 106 can be located on the same physical device, or performance data source 102 and the server 106 can be distributed on different physical devices. The performance data source 102 and the server 106 can communicate via a communications network, for example the communications network 104.

The performance data source 102 contains performance data associated with one or more investment accounts. Although one data source 102 is shown, there can be multiple data sources in the system 100. The data source 102 can be a database residing on a computing device (e.g., a server) running a database management application, such as SQL Server from Microsoft Corp. In some examples, the data source 102 can be associated with a third-party application such as a standalone performance reporting engine. An example performance reporting engine is CHECKFREE Caliper® from Fiserv, Inc. The performance reporting engine can aggregate investment data for a large number of investment accounts and execute calculations which generate performance data for those accounts, and then store the performance data in an associated data source, e.g., data source 102.

The performance data source 102 can transmit the calculated performance data to the server computing device 106. The performance data source 102 stores the performance data locally, and then transmits the performance data to the server 106 at regular intervals via batch processing. In some examples, the data source 102 can send the performance data in a single transmission or send subsets of the entire population of performance data in several smaller transmissions.

The server computing device 106 communicates with the performance data source 102 via a communications network, e.g., communications network 104. The server 106 includes a data collection module 108 and a data filtration module 110. The data collection module 108 provides a data interface between the performance data source 102 and the server 106. The data collection module 108 receives performance data from the data source 102. The data filtration module 110 can generate a tolerance range to be used in identifying a portion of the performance data to filter. The data filtration module 110 can process the received performance data through a plurality of filters in order to identify one or more data points within the performance data that either require or do not require further review. The server 106 can be implemented with one computing device or distributed over several computing devices. Similarly, each of the modules 108 and 110 can be implemented on a single computing device or distributed over several computing devices.

The communications network 104 channels communications from the performance data source 102 to the server 106. The network 104 may be a local network, such as a LAN, or a wide area network, such as the Internet or the World Wide Web. The mobile device 102 and the server 106 can transmit data using a standard transmission protocol, such as XML, SMS, or other similar data communication techniques.

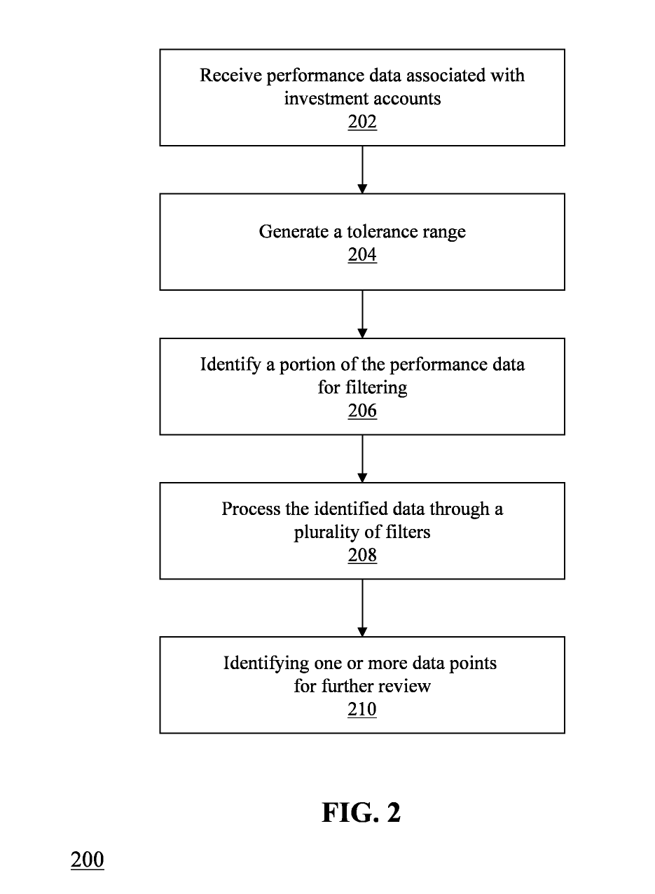

FIG. 2 is a flow diagram of an exemplary method for quality control of investment performance calculations using the system 100. The data collection module 108 in the server 106 receives (202) performance data from the performance data source 102 via the communications network 104. The data filtration module 110 in the server 106 generates (204) a tolerance range. The tolerance range can be generated, for example, based on a configurable parameter by a user of the system. The data filtration module 110 identifies (206) a portion of the performance data for filtering. This portion can be, for example, the data that falls outside of the generated tolerance range. The data filtration module 110 processes (208) the identified portion of the performance data through a plurality of filters. The data filtration module 110 identifies (210) one or more data points within the identified portion of the performance data for further review. The data filtration module 110 also identifies one or more data points within the identified portion of the performance data that, according to the filter processing, requires no further review. Advantageously, this reduces the number of data points outside of the tolerance range, sometimes referred to as outliers, that must be investigated further.

The performance data includes a group of one or more data points associated with individual investment accounts. The data points can include any number of different metrics related to defining the change in asset value (e.g., the gain or loss) of the related investment accounts over a specified time period. The data points can also have different levels of granularity. The data points can be related to individual holdings (e.g., stocks) or transactions in the investment account, or the data points can be associated with the account as a whole. Some example metrics include time-weighted rate of return (TW-ROR), money-weighted rate of return (MW-ROR), and the like. The TW-ROR and the MW-ROR measure different aspects of the performance of an investment account. For example, TW-ROR measures the compound rate of return over a given period for one unit of money. MW-ROR, by contrast, measures the compound growth rate in the value of all funds invested in the account over the specified time period. MW-ROR represents the average growth rate of all money invested, while TW-ROR represents the growth of a single unit invested. MW-ROR is sensitive to the timing of external cash flows, whereas TW-ROR is not affected. Due to these differences, in some examples, TW-ROR can be a preferred indicator to measure account performance over a particular time period because it is not related to the timing and size of cash flows to or from the account. However, MW-ROR is more germane to the average investor because it measures the return on money invested and many brokerage firms want to provide MW-ROR to its individual investors.

Another aspect of the relationship between TW-ROR and MW-ROR is that the calculation for TW-ROR is the same as the calculation for MW-ROR upon excluding cash flows for the account. Therefore, MW-ROR can be validated by excluding cash flows during the period of performance measurement and then comparing the MW-ROR to the TW-ROR. However, it should be noted that the performance data is not restricted to MW-ROR or TW-ROR. The performance data can include any metric used to calculate a gain or loss, or any other types of performance measurements, of an investment account.

The performance data source 102 transmits the performance data to the server 106, where the data is received by the data collection module 108. The performance data source 102 can transmit the performance data in a single batch or the data source 102 can partition the performance data into smaller groups and transmit the smaller groups at different times. In other examples, the performance data source 102 can transmit the performance data to the server 106 continuously and in real time as the data is generated.

Referring to FIG. 2, the data filtration module 110 in the server 106 generates (204) a tolerance range. Due to the complexity and volume of the performance data received by the data collection module 108 from the performance data source 102, the performance data associated with individual investment accounts may include incorrect, missing, or unusual values. The incorrect, missing, or unusual values manifest themselves by altering the rate of return for a given investment account such that the rate of return exceeds an expected threshold. As a result, the data filtration module 110 needs to identify the portion of data containing these incorrect, missing, or unusual values for filtering via the plurality of filters.

One way to accomplish this identification is for the data filtration module 110 to generate a tolerance range that can be applied to one or more data points within the performance data. The tolerance range can comprise a series of data values based upon one or more of the data points within the performance data. Using the TW-ROR example, the data filtration module 110 can generate a TW-ROR tolerance range (e.g., −25% to +25%) for a specific time period. In this example, any investment account that is determined to have a TW-ROR percentage value falling within the tolerance range (e.g., +5%) is not identified for filtering. In contrast, an investment account that has a TW-ROR percentage value falling outside the tolerance range (e.g., −40%) is identified for filtering.

In some examples, the data filtration module 110 can use predetermined default values in generating the tolerance range. The data filtration module 110 can adjust the default values based on, for example, external factors such as market performance benchmarks (e.g., S&P 500 index) or internal factors such as numeric distribution of performance data metrics, prior experience and evaluation of performance data, and the like.

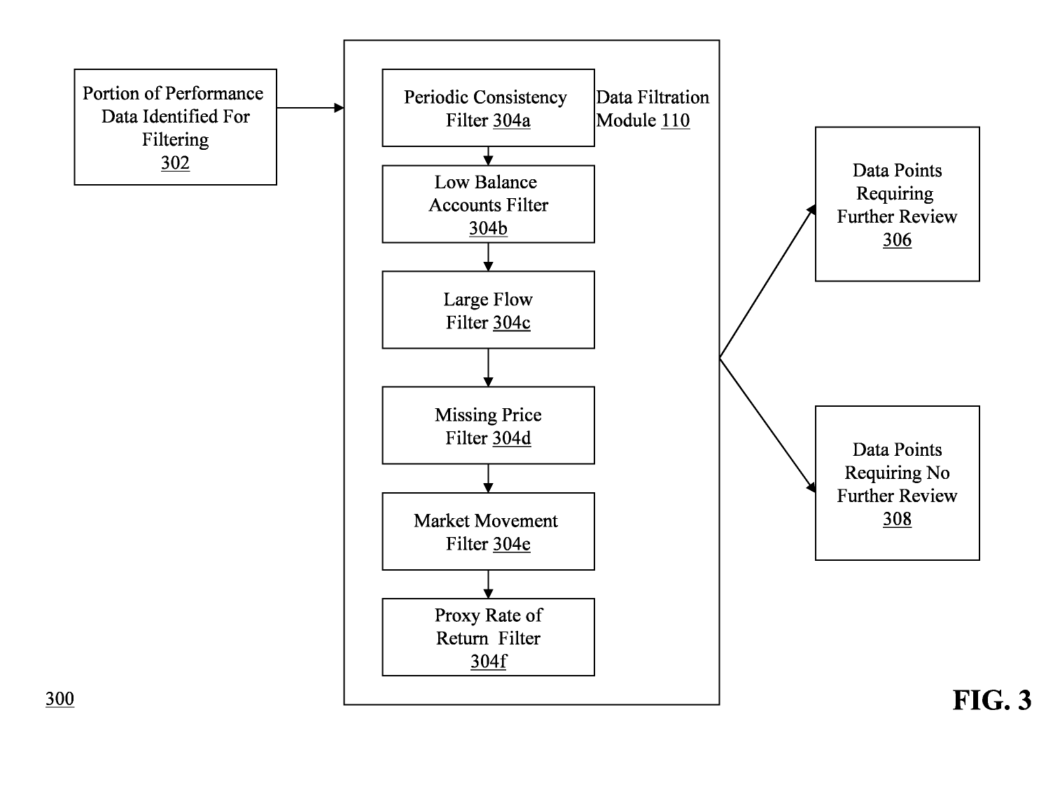

Once the tolerance range is generated and at least a portion of the performance data has been identified for filtering because, for example, that portion falls outside of the tolerance range, the data filtration module 110 processes (208) the identified portion of the performance data through a plurality of filters. The filters (shown in FIG. 3 as blocks 304a-f) can be based on predefined rules. The predefined rules can be of a number of different types, including but not limited to, a market performance type, a missing data type, an account activity type, an estimated return type, and a prior resolution type.

The predefined rules can be defined to encompass certain subjects of performance data evaluation that, based on knowledge and experience with common data errors or discrepancies, have led to consistent disposition of data outliers. The rules advantageously provide a uniform resolution to frequently-seen problems with the performance data, which allows for more efficient processing. For example, a filter based on a rule of missing data type (e.g., missing price filter 304d) can quickly process the data points within the performance data that are missing a required value, and identify those data points for further review. As a result, many data points within the performance data can be processed in a single filtration, thereby reducing the remaining performance data population that requires processing by the data filtration module 110.

FIG. 3 is a detailed block diagram 300 of the plurality of filters 304a-f within the data filtration module 110 of the system 100 for processing investment performance data to identify one or more data points requiring further review. The identified portion of the performance data 302 is received by the data filtration module 110. The performance data 302 is then processed through a plurality of filters 304a-f. The filters shown in diagram 300 include a periodic consistency filter 304a, a low balance account filter 304b, a large flow filter 304c, a missing price filter 304d, a market movement filter 304e, and a proxy rate of return (P-ROR) filter 304f. As the performance data is passed through each filter, one or more data points within the performance data may be identified as either requiring further review (e.g., data points 306) or not requiring further review (e.g., data points 308).

The filters 304a-f can process the identified portion of the performance data serially or concurrently. Processing the performance data serially through the respective filters provides the advantage of narrowing the population of data that requires additional processing, meaning that the first filter processes and identifies a certain number of data points within the performance data for further review, and the remaining filters do not have to process the same identified data. Along with arranging the filters serially, the data filtration module 110 can sequence the filters in a predetermined processing order. The data filtration module 110 can process the data through a first filter that generally will identify the greatest number of data points for further review. For example, if the most common cause of performance data falling outside the tolerance range is a missing price, the data filtration module 110 can process the performance data through the missing price filter 304d first, thereby directly identifying the largest possible number of data points for review. Thus, the population of performance data for the remaining filters to process is greatly reduced.

It should be noted that although FIG. 3 shows the filters in a specific order, the filters 304a-f can be arranged in any order. The order of the filters 304a-f can be based on the characteristics or content of the performance data 302 or other processing factors related to the amount or type of data that needs to be processed by the data filtration module 110. Also, the data filtration module 110 does not have to process the performance data through the filters serially. In other examples, the data filtration module 110 can process the data through multiple filters concurrently in order to improve processing efficiency.

Each of the filters 304a-f evaluates the identified portion of the performance data based on specific criteria related to the investment account as a whole or individual positions within the account. The aim of the filters is to reduce the population of data points within the identified portion of the performance data that require further review. Due to the vast amount of performance data that the performance data source 102 generates each day, the system 100 can achieve greater efficiency by limiting the amount of performance data that requires further review.

The periodic consistency filter 304a compares performance data for accounts associated with the current period against performance data for the same accounts from a prior period. An important feature of this comparison is that the prior performance data has already been processed and determined to be valid by the system 100.

For example, if an investment account had a TW-ROR of 35% for the previous week and the previous week's tolerance threshold was 25%, the system 100 would have processed and identified the TW-ROR for filtering. If, upon filtering, the data filtration module 110 determined that the prior TW-ROR is valid (or alternatively, a manual review determined the validity), a record of that determination would be stored in a data set associated with the periodic consistency filter 304a. Moving to the current week, the TW-ROR for the same account (e.g., 33%) may exceed the tolerance threshold of 25% again. The periodic consistency filter 304a can compare the prior week's TW-ROR against the current week's TW-ROR to see if the two values are similar. Such a similarity may indicate that the data filtration module 110 should find current week's TW-ROR to be valid, and therefore identify the TW-ROR as not requiring further review 308.

Determination of similarity between the respective performance data can comprise identifying the data points as not requiring further review if the current performance data is within a predetermined consistency tolerance of the prior performance data. Continuing with the above example, the predetermined consistency tolerance can be 3%. Since the current week's TW-ROR (e.g., 33%) is less than 3% different than the prior week's TW-ROR (e.g., 35%), the periodic consistency filter 304a can identify the TW-ROR as not requiring further review 308.

The low balance filter 304b evaluates performance data associated with investment accounts that contain a low market value. A low market value can be defined as the total asset value in the account not exceeding a specified threshold (e.g., $1,000.00). One consequence of an account having low market value is increased susceptibility to exaggerated performance data changes when money flows into or out of the account. For example, if an investment account with a starting value of $200.00 receives a stock dividend of $70.00 during one week and the value of the account does not otherwise change, the rate of return calculated for that account would be 35%. Consequently, the performance data for the account would be identified by the data filtration module 110 as falling outside the tolerance range (e.g., −25% to +25%). Thus, the performance data for the account is considered an outlier and is identified for processing by the data filtration module 110. However, since the low balance in the account caused the rate of return to appear exceedingly high, the low balance filter 304b compares the account balance with the threshold and determines that the data points associated with the account do not require further review. Instead, the rate of return is presumed valid based on the fact that the account has a low balance. As a result, the data points are identified as requiring no further review 308 and the data filtration module 110 processes them accordingly.

The large flow filter 304c evaluates performance data associated with investment accounts that experience substantial positive or negative cash flows during a specified posting period. A cash flow can be defined as a contribution to or a withdrawal from an individual investment account. Large cash flows can produce unexpected results in the calculation of TW-ROR, and since verification of MW-ROR is dependent on TW-ROR, the MW-ROR for accounts with large cash flows cannot be verified using the TW-ROR. Therefore, the data points (e.g., TW-ROR) for accounts experiencing large cash flows during a given period are identified as requiring further review. In order to identify these data points, the large flow filter 304c determines the criteria for a large flow. In some examples, determination of a large flow can be based on the previous month's market value of the account. The large flow filter 404c determines a cash flow threshold (e.g., 10%), and the filter 304c will detect any investment accounts which had a cash contribution to the account or a cash withdrawal from the account exceeding the threshold. For example, if the cash flow threshold is set at 10% and an investment account with a market value of $200,000.00 at the end of the previous month incurred a cash withdrawal of $50,000.00 (i.e., 25% of the previous market value) during the current posting period, the large flow filter 304c would identify the data points associated with this account as requiring further review 308.

The missing price filter 304d evaluates performance data associated with investment accounts where one or more positions (e.g., a specific stock or other security) within the account have a missing or zero price during a specified posting period. Generally, a missing price will result in the market value of a position to drop to zero, resulting in incorrect performance data for the account. For example, if an individual account contains 100 shares of stock in Company A, and the performance data source 102 erroneously records the price of a share of Company A′s stock as $0.00, the market value of the stock will drop to zero and affect, for example, the TW-ROR for that account. The missing price filter 304d identifies the data points associated with that account as requiring further review.

The missing price filter 304d also evaluates performance data associated with investment accounts where one or more positions within the account are considered worthless, that is, the market value of the positions is very small, so as to be negligible. For example, a stock might have dropped in value to the point where the stock price is less than one penny. Although the price is technically not zero or missing, the missing price filter 304d identifies the data points associated with that account as requiring further review.

The market movement filter 304e accounts for significant shifts in performance across the entire investment market when processing the performance data. An overall market benchmark is selected, and the tolerance range is adjusted by a value equal to the change in the market benchmark. Examples of market benchmarks include the S&P 500 Index, the Dow Jones Industrial Average (DJIA), or other similar indicators of market performance. For example, if the default tolerance range for the TW-ROR during one week is −25% to +25%, and the market benchmark for the same week indicates that the market increased in overall value by 3.5%, the tolerance range would be adjusted to −21.5% to +28.5% in order to account for the increase. The performance data for one or more of the investment accounts is then compared against the tolerance range to determine if the performance data still falls outside the range. Continuing with the above example, if the TW-ROR for an investment account is +26%, that account would have been identified for filtering. Then, as that TW-ROR is filtered, the market movement filter 304e determines that due to the market benchmark adjustment, the TW-ROR of +26% does indeed fall within the adjusted tolerance range and therefore the data points associated with that individual investment account are identified as requiring no further review.

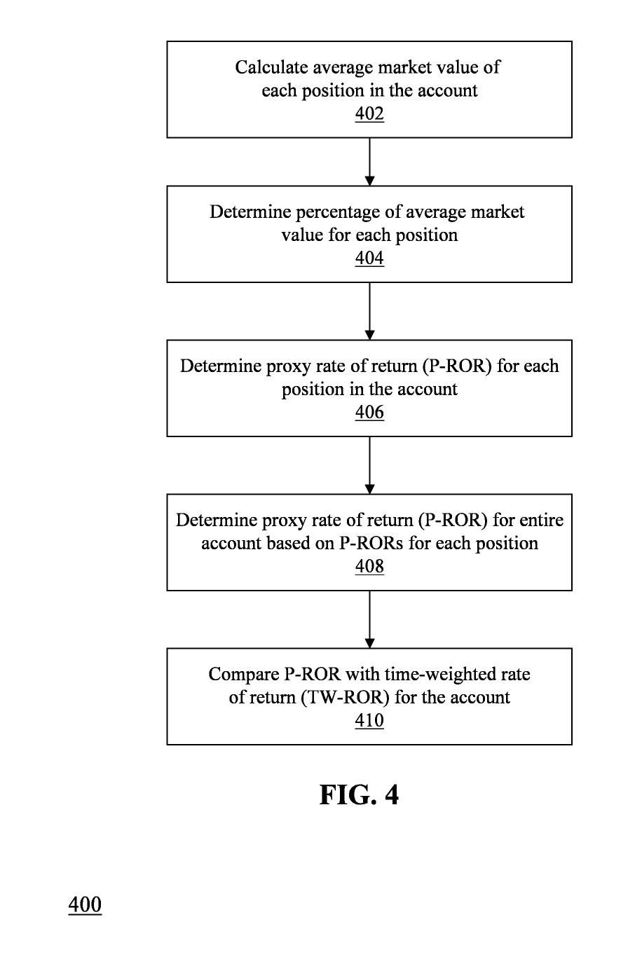

The P-ROR filter 304f calculates a P-ROR for one or more investment accounts and compares the P-ROR with the calculated TW-ROR for the same account. FIG. 4 is a flow diagram 400 of a proxy rate of return calculation according to the proxy rate of return filter 304d. The P-ROR filter 304f calculates (402) the average market value for each position in the account. The P-ROR filter 304f retrieves the beginning market value (e.g., the price and number of shares at the start of the week) and the ending market value (e.g., the price and number of shares at the end of the week) for each position, and determines the average market value of each position for the week. The P-ROR filter 304f determines (404) a percentage of total average market value for each position based on the average market value of the position and the total average market value of the account. The P-ROR filter 304f then determines (406) a P-ROR for each position in the account based on the rate of return for that position and the percentage of total average market value for that position. The P-ROR filter 304f then determines (408) a P-ROR for the entire account based on the P-ROR for each position in the account. The P-ROR filter 304f then compares (410) the calculated P-ROR for the account with the TW-ROR associated with that same account in the performance data to determine if there is a difference between the two rates.

Below is an example calculation of the P-ROR for an investment account. Table A shows an investment account containing five positions at the start of the week, with quantities of 100 shares of stock in Companies A, B, C, D, and F, and zero shares in Company E. During the week, several transactions are executed. Table A also contains the market value of each position at the start and end of the week.

TABLE A

| | Quantity at | Market Value | Quantity at | Market Value |
|---|---|---|---|---|
| | Start of | at Start of | End of | at End of |
| Company | Week | Week | Week | Week |
| A | 100 | 1,000 | 50 | 550 |
| B | 100 | 10,000 | 100 | 12,000 |
| C | 100 | 5,000 | 0 | 0 |
| D | 100 | 1,200 | 100 | 1,300 |
| E | 0 | 0 | 100 | 1,400 |
| F | 100 | 200 | 100 | 300 |
| Net MV | | 17,400 | | 15,550 |
| Gross | | 17,400 | | 15,550 |
| MV | | | | |

Table B shows the stock price of the respective stocks at the start and end of the week, along with the percentage change in value during the week.

TABLE B

| | Stock Price at | Stock Price at | |
|---|---|---|---|
| Company | start of week | end of week | % change |
| A | 10 | 11 | 10.00% |
| B | 100 | 120 | 20.00% |
| C | 50 | 45 | −10.00% |
| D | 12 | 13 | 8.33% |
| E | 15 | 14 | −6.67% |
| F | 2 | 3 | 50.00% |

Table C shows the calculation of the average market value, the percentage of gross average market value, and the P-ROR weighted by market value for each of the stocks.

TABLE C

| | | | P-ROR |
|---|---|---|---|
| | Average Market | % of Gross Avg | weighting by |
| Company | Value | Market Value | Market Value |
| A | 788 | 4.81% | 0.48% |
| B | 11,000 | 67.12% | 13.42% |
| C | 2,375 | 14.49% | −1.45% |
| D | 1,250 | 7.63% | 0.64% |
| E | 725 | 4.42% | −0.29% |
| F | 250 | 1.53% | 0.76% |
| Total Avg | 16,388 | | 13.56% |
| Market Value | | | |

For example, the P-ROR filter 304f determines that the average market value of Company A stock during the week by adding the starting market value (e.g, $10*100 shares=$1,000) and the ending market value (e.g., $11*50 shares=$550), and dividing the result ($1,550) by two, equaling $788. The P-ROR filter 304f does the same determination for each of the other stocks, resulting in a total average market value for the account of $16,388. The P-ROR filter 304f then determines the percentage of total average market value that the Company A stock comprises by dividing the average market value of Company A stock by the total average market value for the account (e.g., $788/$16,388=4.81%). Again, the P-ROR filter 304f does the same determination for each of the other stocks. As a third step, the P-ROR filter 304f determines the P-ROR for Company A stock by multiplying the rate of return for Company A stock by the percentage of total average market value for Company A stock (e.g., 10%*4.81%=0.48%), meaning that the Company A stock contributes 0.48% rate of return to the overall rate of return for the account during the week. After the P-ROR filter 304f calculates the P-ROR for each of the other stocks, the filter 304d adds up the respective P-RORs to determine a P-ROR for the entire account (e.g., 13.56%).

Once the P-ROR filter 304f has determined the P-ROR for the entire account, the filter 304d compares the P-ROR with the TW-ROR data point within the performance data associated with the same account. If the two RORs are within a certain tolerance percentage of each other, the filter 304d can identify the TW-ROR data point as requiring no further review 308. The tolerance percentage can be predetermined by the filter 304d. Using the above example, if the tolerance percentage is 1%, the filter 304d would validate a TW-ROR between 12.56% and 14.56% as requiring no further review. In contrast, the filter 304d would identify a TW-ROR of 17% as requiring further review because the TW-ROR exceeds the tolerance percentage.

After the data filtration module 110 has processed the performance data through a filter, one or more data points within the performance data can be identified as either requiring further review 306 or requiring no further review 308.

For data points identified as requiring no further review 308, the data filtration module 110 can store data associated with the data points 308 into a data set associated with the periodic consistency filter 304a. In some examples, the data set can be a table or other data structure contained in a database which the periodic consistency filter 304a can access. The data filtration module 110 can, for example, insert an entry into the database table for each of the one or more identified data points 308 associated with an individual investment account. The entry can contain data elements such as an identifier associated with the investment account, a timestamp, a corrected data value, a closure flag, and a comment text field. The insertion of a record can indicate, for example, that a TW-ROR that had fallen outside the tolerance range is actually valid based on the determination of a filter in the data filtration module 110.

For data points associated with an investment account identified as requiring further review (e.g., data points 306), the data filtration module 110 can prepare and output the data points 306 for review in a number of different ways. In one example, the identified data points 306 are stored in a data structure (e.g., a database) for use by another application. In another example, the identified data points 306 are displayed on a screen or terminal for manual review. In yet another example, the identified data points 306 are transmitted to a printing device for production of a physical copy of the points. Further review of the points 306 can take the form of manual review by a technician or other representative, or review of the points 306 alternatively can be conducted by a computing device or other apparatus that is outside the scope of this invention.

During review, the points 306 are examined to determine the source of the discrepancy. The points 306 can be corrected or validated as correct, and a data entry can be inserted into a data set associated with the periodic consistency filter 304a, just as in the case of data points 306 requiring no further review. This entry can be used in subsequent weeks for comparison against the same or similar discrepancies associated with the same account. Once the data points are reviewed and an entry is made, the data filtration module 110 can release the data points 306 from the identified portion of performance data, thereby reducing the remaining population of data points that contain a discrepancy.

Another aspect of the system 100 involves an iterative month-to-date posting schedule for performance data that has been identified, processed, and released according to the above description. This technique has the advantage of identifying and resolving performance data discrepancies during the period in which they occur, and incorporating the previous period's validated performance data into the current period's processing. As a result, the system 100 can learn from the previous resolution of outliers and conduct a more efficient and accurate review of data of subsequent periods.

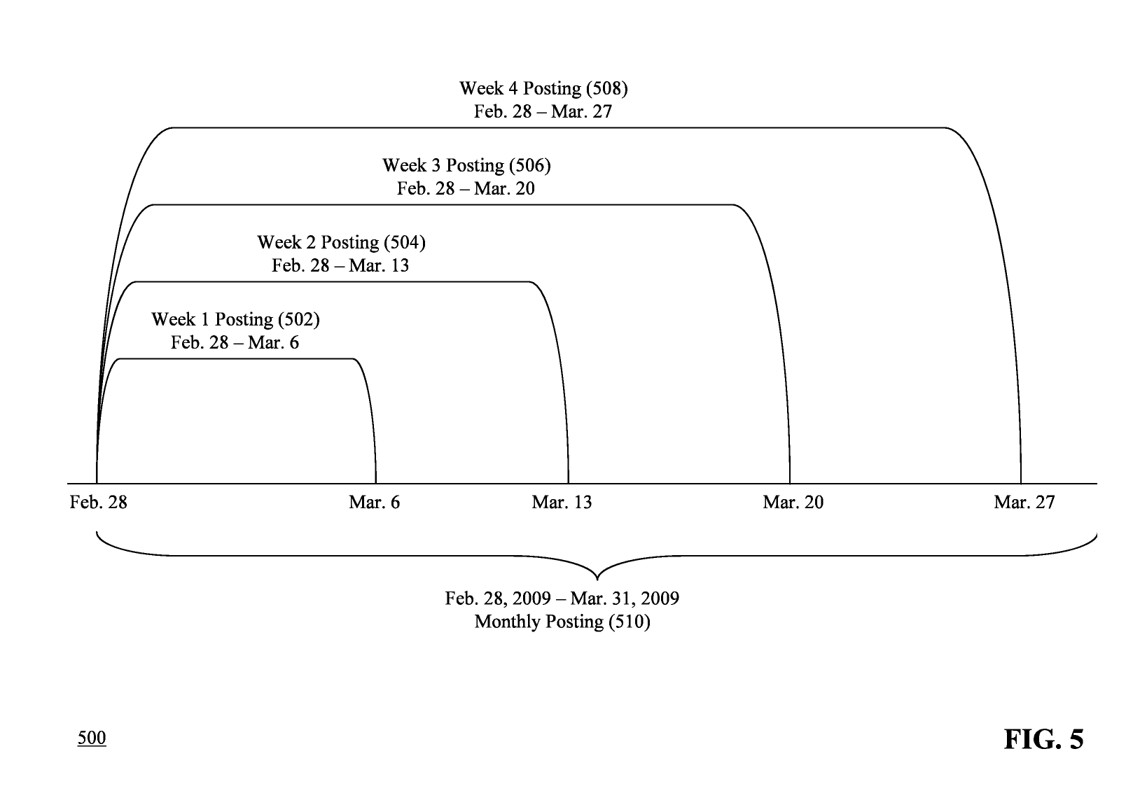

FIG. 5 is a diagram depicting an exemplary iterative month-to-date posting period schedule 500. For example, the data collection module 108 receives performance data from the performance data source 102 during the first week of the month, e.g., February 28 to March 6 (reference number 502). At the end of the week, the data filtration module 110 completes the identification, processing, and resolution of performance data falling outside the defined tolerance range, and a posting of the week's verified performance data is made. The posting can occur, for example, by the data filtration module 110 storing the verified performance data in a database or other data storage module.

During the subsequent week, e.g., March 7^{th} to March 13^{th} (reference number 504), the data collection module 108 receives performance data associated with that week from the performance data source 102. During processing, the data filtration module 108 can reference the first week's verified performance data for use in comparison with the second week's outliers. At the end of the second week 504, the data filtration module 110 can make another posting of the performance data. This time, the posted performance data includes verified data from the first two weeks 502 and 504 of the month—resulting in month-to-date performance data associated with the investment account. The system 100 repeats this process for the subsequent weeks of the month 506 and 508, and makes a complete month posting 510 of the performance data at the end of the month.

The above-described systems and methods can be implemented in digital electronic circuitry, in computer hardware, firmware, and/or software. The implementation can be as a computer program product (i.e., a computer program tangibly embodied in a computer readable storage medium). The implementation can, for example, be in a machine-readable storage device and/or include a propagated signal, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array), an ASIC (application-specific integrated circuit), a DSP (digital signal processor), and/or any other discrete circuitry that is configured to implement the required functions. Modules, subroutines, and software agents can refer to portions of the computer program, the processor (included in a computing device, such as a server computing device), the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Computer readable mediums suitable for embodying computer program instructions and data include all forms of non-volatile memory, including by way of example semiconductor memory devices. The computer readable mediums can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device or a transmitting device. The display device can be, for example, a cathode ray tube (CRT) and/or a liquid crystal display (LCD) monitor. The interaction with a user can be, for example, a display of information to the user and a keyboard and a pointing device (e.g., a mouse or a trackball) by which the user can provide input to the computer (e.g., interact with a user interface element). Other kinds of devices can be used to provide for interaction with a user. Other devices can be, for example, feedback provided to the user in any form of sensory feedback (e.g., visual feedback, auditory feedback, or tactile feedback). Input from the user can be, for example, received in any form, including acoustic, speech, and/or tactile input.

The client device and the computing device can include, for example, a computer, a computer with a browser device, a telephone, an IP phone, a mobile device (e.g., cellular phone, personal digital assistant (PDA) device, smart phone, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a Blackberry®.

The web servers can be, for example, a computer with a server module (e.g., Microsoft® Internet Information Services available from Microsoft Corporation, Apache Web Server available from Apache Software Foundation, Apache Tomcat Web Server available from Apache Software Foundation).

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network).

The system can include clients and servers. A client and a server are generally remote from each other and typically interact through a communication network. The relationship of client and server arises by virtue of computer programs running on the respective computers and having a client-server relationship to each other.

The above described communication networks can be implemented in a packet-based network, a circuit-based network, and/or a combination of a packet-based network and a circuit-based network. Packet-based networks can include, for example, the Internet, a carrier interne protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth, code-division multiple access (CDMA) network, time division multiple access (TDMA) network, global system for mobile communications (GSM) network), and/or other circuit-based networks.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein.

What is claimed is:

1. A computerized method for quality control of investment performance calculations, the method comprising:
receiving, by a server computing device, performance data associated with one or more investment accounts;
generating a tolerance range associated with the performance data;
identifying a portion of the performance data for filtering based on the tolerance range;
processing the identified portion of the performance data through a plurality of filters, wherein the filters are based on predefined rules;
identifying one or more data points within the identified portion of the performance data as requiring no further review based on the processing; and
identifying one or more data points within the identified portion of the performance data as requiring further review based on the processing.

2. The method of claim 1, the identifying a portion of the performance data for filtering based on the tolerance range comprises comparing the performance data with the tolerance range, and identifying the portion of the performance data that is not within the tolerance range.

3. The method of claim 1, wherein identifying one or more data points within the identified portion of the performance data as requiring no further review based on the processing includes inserting data associated with the one or more data points requiring no further review into a data set associated with one of the plurality of filters.

4. The method of claim 3, wherein the inserted data includes an identifier associated with an investment account, a timestamp, a corrected data value, a closure flag, a comment text field, or any combination thereof.

5. The method of claim 1, the processing further comprising processing the identified performance data serially through the plurality of filters, wherein the plurality of filters is arranged in a predetermined order.

6. The method of claim 1, wherein the predefined rules include a market performance type, a missing data type, an account activity type, an estimated return type, and a prior resolution type.

7. The method of claim 6, wherein the predefined rule is a market performance type, the processing further comprising adjusting the performance data based on market movement data.

8. The method of claim 6, wherein the predefined rule is a missing data type, the processing further comprising determining that at least a portion of the performance data has a zero or missing price.

9. The method of claim 8, further comprising determining that the portion of the performance data with a zero or missing price is associated with an investment security having no value.

10. The method of claim 6, wherein the predefined rule is an account activity type, the processing further comprising determining that at least a portion of the performance data is associated with one or more investment accounts having a low asset value.

11. The method of claim 6, wherein the predefined rule is an account activity type, the processing further comprising determining that a portion of the performance data is associated with one or more investment accounts having a change in asset value that exceeds a minimum percentage.

12. The method of claim 6, wherein the predefined rule is an estimated return type, the processing further comprising:
calculating a proxy rate of return for at least a portion of the identified performance data;
comparing the proxy rate of return with the performance data; and
determining that the one or more data points within the identified portion of the performance data do not require further review based on the comparison.

13. The method of claim 6, wherein the predefined rule is a prior resolution type, the processing further comprising:
comparing one or more data points within the identified performance data with resolution data from a selected time period, wherein the one or more data points of the identified performance data and the resolution data are associated with the same investment account; and
determining that the one or more data points of the identified performance data do not require further review based on the comparison.

14. The method of claim 13, wherein the resolution data is associated with one or more data points identified during the selected time period as requiring further review.

15. The method of claim 13, wherein the selected time period is the previous week.

16. The method of claim 13, wherein the selected time period is the month-to-date.

17. The method of claim 1, wherein the performance data is a money weighted rate-of-return, a time-weighted rate of return, or any combination thereof.

18. The method of claim 17, wherein the money weighted rate-of-return and the time weighted rate-of-return are associated with a single investment account.

19. The method of claim 1, wherein the tolerance range is based on a distribution of at least a portion of the performance data.

20. A system for quality control of investment performance calculations, the system comprising:
a server computing device configured to:
receive performance data associated with one or more investment accounts;
generate a tolerance range associated with the performance data;
identify a portion of the performance data for filtering based on the tolerance range;
process the identified portion of the performance data through a plurality of filters, wherein the filters are based on predefined rules;
identify one or more data points within the identified portion of the performance data as requiring no further review based on the processing; and
identify one or more data points within the identified portion of the performance data as requiring further review.

21. A computer program product for quality control of investment performance calculations, tangibly embodied in a computer readable storage medium, the computer program product including instructions operable to cause a data processing apparatus to:
receive performance data associated with one or more investment accounts;
generate a tolerance range associated with the performance data;
identify a portion of the performance data for filtering based on the tolerance range;
process the identified portion of the performance data through a plurality of filters, wherein the filters are based on predefined rules;
identify one or more data points within the identified portion of the performance data as requiring no further review; and
identify one or more data points within the identified portion of the performance data as requiring further review.

22. A system for quality control of investment performance calculations, the system comprising:
means for receiving performance data associated with one or more investment accounts;
means for generating a tolerance range associated with the performance data;
means for identifying a portion of the performance data for filtering based on the tolerance range;
means for processing the identified portion of the performance data through a plurality of filters, wherein the filters are based on predefined rules;
means for identifying one or more data points within the identified portion of the performance data as requiring no further review; and
means for identifying one or more data points within the identified portion of the performance data as requiring further review.
